(19) United States
(12) Patent Application Publication
(10) Pub. No.: US 2026/0366777 A1
(43) Pub. Date: Nov. 19, 2026

(54) BACKUP BEARINGS FOR A COMPRESSOR

(71) Applicant: Tyco Fire & Security GmbH, Neuhausen am Rheinfall (CH)

(72) Inventors: Bryson Lee Sheaffer, Mechanicsburg, PA (US); Jordan Quinn Steiner, York, PA (US); Paul William Snell, York, PA (US)

(21) Appl. No.: 19/153,939

(22) PCT Filed: Feb. 7, 2024
(86) PCT No.: PCT/US2024/014799

§ 371 Date: Aug. 5, 2025

Related U.S. Application Data
(60) Provisional application No. 63/443,921, filed on Feb. 7, 2023.
(60) Provisional application No. 63/460,227, filed on Apr. 18, 2023.

(51) Int. Cl. F25B 31/02; F16C 17/02; F16C 19/00

(52) U.S. Cl. CPC F25B 31/02; F16C 17/02; F16C 19/00; F16C 2362/52; F25B 2400/07

(57) ABSTRACT

A compressor for a heating, ventilation, air conditioning, and refrigeration (HVAC&R) system includes a compressor housing and a shaft configured to rotate within the compressor housing. The compressor also includes a primary bearing annularly disposed about the shaft. The primary bearing is configured to receive a flow of pressurized fluid and to discharge the pressurized fluid toward the shaft. Additionally, the compressor includes a backup bearing annularly disposed about the shaft. The backup bearing is configured to engage with the shaft during an operational interruption to the primary bearing.

### CROSS-REFERENCE TO RELATED APPLICATIONS

This application claims priority from and the benefit of U.S. Provisional Application No. 63/460,227, entitled “BACKUP BEARINGS FOR COMPRESSOR,” filed Apr. 18, 2023, and U.S. Provisional Application No. 63/443,921, entitled “BEARING SYSTEM FOR HVAC&R SYSTEM,” filed Feb. 7, 2023, each of which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof in response to exposure to different temperatures and pressures within components of the chiller system. The chiller system may place the working fluid in a heat exchange relationship with a cooling fluid (e.g., water) and may deliver the cooling fluid to conditioning equipment and/or a conditioned environment serviced by the chiller system. In such applications, the cooling fluid may be directed through downstream equipment, such as air handlers, to condition other fluids, such as air in a building. The chiller system may include a compressor configured to pressurize the working fluid and circulate the working fluid through a working fluid circuit of the chiller system. In some applications, a shaft of the compressor may be driven in rotation by a motor in order to drive rotation of an impeller of the compressor that pressurizes the working fluid. Traditionally, the compressor includes bearings configured to facilitate rotation and support loads on the shaft. Unfortunately, in some circumstances, bearings may operate improperly during operation of the compressor, which may adversely impact operation of the chiller system and degrade the condition of the chiller system.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a compressor for a heating, ventilation, air conditioning, and refrigeration (HVAC&R) system includes a compressor housing and a shaft configured to rotate within the compressor housing. The compressor also includes a primary bearing annularly disposed about the shaft. The primary bearing is configured to receive a flow of pressurized fluid and to discharge the pressurized fluid toward the shaft. Additionally, the compressor includes a backup bearing annularly disposed about the shaft. The backup bearing is configured to engage with the shaft during an operational interruption to the primary bearing.

In another embodiment, a heating, ventilation, air conditioning, and refrigeration (HVAC&R) system includes a compressor having a compressor housing and a shaft configured to rotate within the compressor housing. The HVAC&R system further includes a first bearing disposed about the shaft. The first bearing is configured to receive a pressurized fluid and to discharge the pressurized fluid toward the shaft. Additionally, the first bearing is configured to establish a first clearance distance between the first bearing and the shaft during operation of the compressor. Furthermore, the HVAC&R system includes a second bearing disposed about the shaft. The second bearing is configured to establish a second clearance distance between the second bearing and the shaft during operation of the shaft. The first clearance distance is less than the second clearance distance. Additionally, the HVAC&R system includes a fluid supply system configured to direct the pressurized fluid to the primary bearing.

In another embodiment, a bearing assembly for supporting a shaft of a compressor includes a primary bearing disposed about an axis of rotation of the shaft. The primary bearing is configured to discharge a refrigerant inward of the primary bearing, and the primary bearing is configured to establish a first clearance distance between the shaft and the primary bearing during operation of the compressor. The bearing assembly further comprises a backup bearing disposed about the axis of rotation of the shaft. The backup bearing is configured to be establish at a second clearance distance between the backup bearing and the shaft during operation of the compressor. The second clearance distance is greater than the first clearance distance. Additionally, the bearing assembly includes a bearing housing configured to support the primary bearing and the backup bearing.

### BRIEF DESCRIPTION OF THE DRAWINGS

Various aspects of this disclosure may be better understood upon reading the following detailed description and upon reference to the drawings in which:

FIG. 1 is a perspective view of an embodiment of a building that may utilize a heating, ventilating, air conditioning, and refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of a vapor compression system, in accordance with an aspect of the present disclosure;

FIG. 4 is a schematic of an embodiment of the vapor compression system, in accordance with an aspect of the present disclosure;

FIG. 5 is a cross-sectional side view of an embodiment of a compressor of a vapor compression system, illustrating a bearing system of the compressor, in accordance with an aspect of the present disclosure;

FIG. 6 is a cross-sectional side view of an embodiment of a portion of a compressor of a vapor compression system, illustrating a bearing assembly disposed about a shaft of the compressor, in accordance with an aspect of the present disclosure;

FIG. 7 is a cross-sectional side view of an embodiment of a portion of a compressor of a vapor compression system, illustrating a bearing assembly disposed about a shaft of the compressor, in accordance with an aspect of the present disclosure; and

FIG. 8 is as axial view of an embodiment of a bearing assembly of a compressor, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “approximately,” “generally,” and “substantially,” and so forth, are intended to convey that the property value being described may be within a relatively small range of the property value, as those of ordinary skill would understand. For example, when a property value is described as being “approximately” equal to (or, for example, “substantially similar” to) a given value, this is intended to mean that the property value may be within +/−5%, within +/−4%, within +/−3%, within +/−2%, within +/−1%, or even closer, of the given value. Similarly, when a given feature is described as being “substantially parallel” to another feature, “generally perpendicular” to another feature, and so forth, this is intended to mean that the given feature is within +/−5%, within +/−4%, within +/−3%, within +/−2%, within +/−1%, or even closer, to having the described nature, such as being parallel to another feature, being perpendicular to another feature, and so forth. Further, it should be understood that mathematical terms, such as “planar,” “slope,” “perpendicular,” “parallel,” and so forth are intended to encompass features of surfaces or elements as understood to one of ordinary skill in the relevant art, and should not be rigidly interpreted as might be understood in the mathematical arts. For example, a “planar” surface is intended to encompass a surface that is machined, molded, or otherwise formed to be substantially flat or smooth (within related tolerances) using techniques and tools available to one of ordinary skill in the art. Similarly, a surface having a “slope” is intended to encompass a surface that is machined, molded, or otherwise formed to be oriented at an angle (e.g., incline) with respect to a point of reference using techniques and tools available to one of ordinary skill in the art.

Embodiments of the present disclosure relate to a heating, ventilation, air conditioning, and refrigeration (HVAC&R) system (e.g., a chiller) including a vapor compression system (e.g., vapor compression circuit) having a compressor. In operation, the compressor may pressurize a working fluid within the vapor compression system and direct the working fluid to a condenser (e.g., a first heat exchanger), which may cool and condense the working fluid. The condensed working fluid may be directed to an expansion device, which may reduce a pressure of the working fluid, further cooling the working fluid. From the expansion device, the cooled working fluid may be directed to an evaporator (e.g., a second heat exchanger), where the working fluid may be placed in a heat exchange relationship with a conditioning fluid (e.g., cooling fluid) to cool the conditioning fluid. The conditioning fluid may be circulated between the evaporator and a structure, such as a building, where the conditioning fluid is used to cool an air flow delivered to a conditioned space of the structure. In some embodiments, an air handling unit (AHU) of the HVAC&R system may receive the conditioning fluid from the vapor compression system and utilize the conditioning fluid to cool the air flow delivered to the conditioned space. The conditioning fluid may then be returned to the evaporator to be cooled again.

In some embodiments, the compressor may include an impeller configured to rotate to enable pressurization of the working fluid and to direct the working fluid through the vapor compression system. For example, the impeller may be coupled to a shaft, and the shaft may be driven in rotation relative to a housing of the compressor to enable rotation of the impeller relative to the housing. Typically, the compressor includes one or more bearings configured to facilitate rotation of the shaft relative to the housing of the compressor. In accordance with present techniques, the compressor includes one or more primary bearings (e.g., primary bearing system) configured to utilize a pressurized fluid, such as the working fluid (e.g., refrigerant) circulated through the vapor compression system, to support a load of the shaft of the compressor and lubricate rotation of the shaft within the housing of the compressor. In particular, the pressurized fluid may be directed through the one or more primary bearings to cause the pressurized fluid to impinge against the shaft and thereby facilitate rotation of the shaft within the housing. In some instances, normal operation of the primary bearings may be inadvertently interrupted, in which case the shaft may no longer be adequately supported by the primary bearings. In such instances, it is desirable to suspend operation of the compressor in a controlled manner that limits wear and degradation to the compressor and the components of the compressor, including the primary bearings.

Accordingly, present embodiments are directed to a bearing system having backup bearings configured to support the shaft of the compressor and enable rotation of the shaft in the event that operation (e.g., normal operation) of the primary bearings is inadvertently interrupted. The backup bearings may temporarily enable continued operation of the compressor (e.g., rotation of the shaft) during operational interruption of the primary bearings. Additionally, the backup bearings may facilitate a controlled deceleration of the shaft during a shutdown of the compressor in response to interrupted operation of the primary bearings.

As mentioned above, the primary bearings described herein are configured to utilize a pressurized fluid, such as a portion of the working fluid (e.g., refrigerant) circulated through the vapor compression system, to support a load of the shaft of the compressor and enable rotation of the shaft within the housing of the compressor. The pressurized fluid may also function as a lubricant. To this end, the bearing system includes one or more primary bearings having porous bearing elements configured to receive the pressurized fluid. The pressurized fluid (e.g., liquid) may be directed through the porous bearing elements and may then contact the shaft within the housing. As the pressurized fluid is directed through and discharged from the porous bearing elements, the pressurized fluid may vaporize or “flash” to become a vapor or gas that contacts the shaft and forms a hydrostatic film about the shaft. As such, the pressurized fluid creates a clearance (e.g., gap, space, first clearance) between the shaft and the porous bearing elements, such that the shaft is levitated within the housing and from the primary bearings during operation of the compressor. In this way, the working fluid circulated through the vapor compression system to enable heat exchange with other fluids (e.g., a conditioning fluid supplied to a load) may also be utilized as a lubricant (e.g., bearing fluid) that enables desired operation of the compressor. Indeed, present embodiments enable incorporation of primary bearings within the compressor without utilizing a separate, dedicated lubricant, such as oil. Disclosed embodiments of the bearing system may also be implemented at reduced costs (e.g., manufacturing costs, operating costs, maintenance costs) compared to traditional bearings.

Similar to the primary bearings, the backup bearings may also be disposed about the shaft with a clearance (e.g., gap, space, second clearance) extending between the shaft and the backup bearings during operation of the compressor. In some embodiments, a second clearance between the shaft and the backup bearings may be greater than a first clearance between the shaft and the primary bearings. That is, during operation of the compressor and the primary bearings, the backup bearings may not contact the shaft. However, during operational interruption of the primary bearings, the primary bearing may no longer adequately support the shaft. In other words, the primary bearings may not cause the shaft to levitate within the primary bearings. In such instances, the shaft may contact the backup bearings, and the backup bearings may provide adequate support and may enable adequate rotation of the shaft within the housing, such as during a controlled shutdown of the compressor. That is, the shaft may fall from a levitated position to contact the backup bearings, and the backup bearings may provide a bearing interface against which the shaft may rotate. In this way, rotation of the shaft may not be suddenly arrested during operational interruption of the primary bearings, which may otherwise cause wear and degradation to the compressor. The backup bearings may be any suitable type of bearing, such as mechanical bearings. In some embodiments, the backup bearings may include roller bearings, ball bearings, sleeve bearings, bush bearings, skid bearings, journal bearings, magnetic bearings, or any other suitable type of bearing.

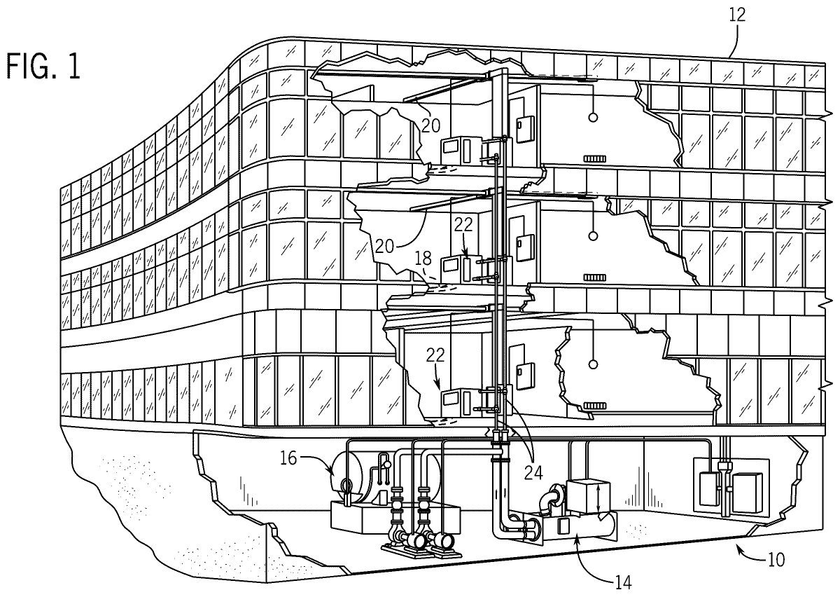

Turning now to the drawings, FIG. 1 is a perspective view of an embodiment of a heating, ventilating, air conditioning, and refrigeration (HVAC&R) system 10 in a building 12 for a typical commercial setting. The HVAC&R system may include a boiler 16 to supply warm liquid to heat the building 12 and a vapor compression system 14 to supply chilled liquid to cool the building 12. The vapor compression system 14, sometimes referred to as a chiller, may circulate a working fluid (e.g., refrigerant) that is cooled by a cooling fluid (e.g., liquid such as water) in a condenser of the vapor compression system 14, and that is heated by a conditioning fluid (e.g., liquid, such as water) in an evaporator of the vapor compression system 14. The cooling fluid may be provided by a cooling tower which cools the cooling fluid via, for example, ambient air. The conditioning fluid, cooled by the working fluid as noted above, may be utilized to cool an air flow provided to conditioned spaces of the building 12.

The HVAC&R system 10 may also include an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or the conditioning fluid (e.g., chilled liquid such as water) from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

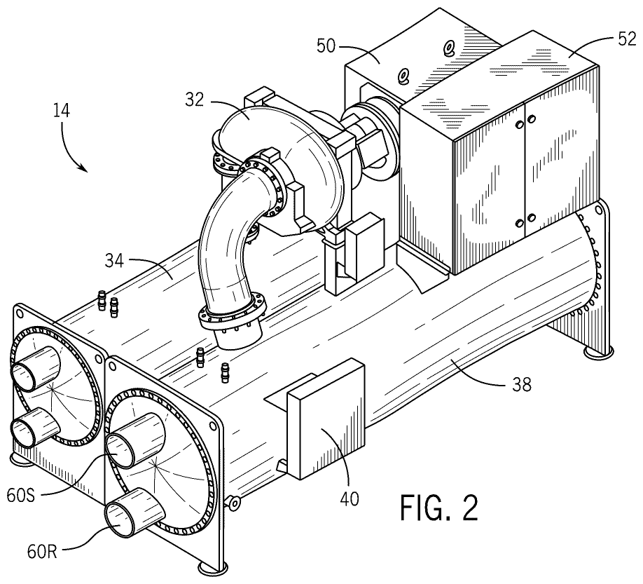

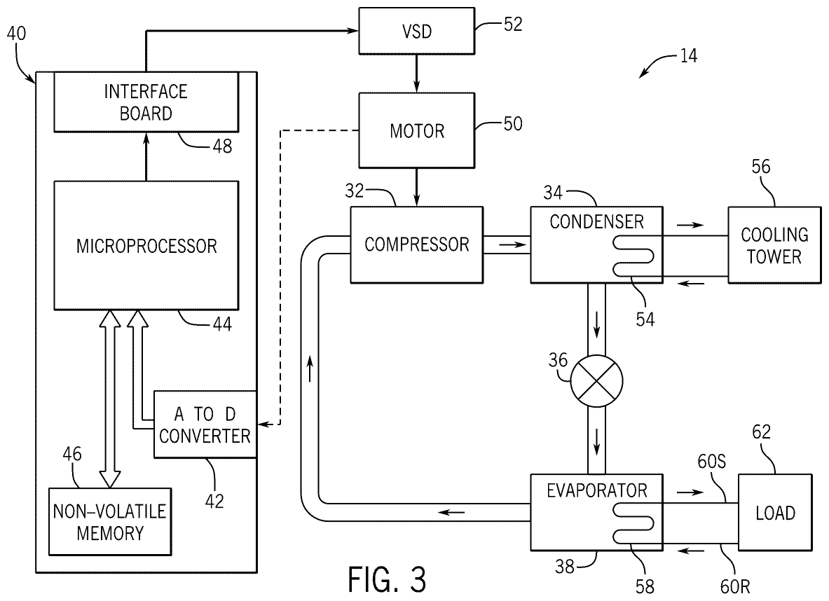

FIGS. 2 and 3 illustrate embodiments of the vapor compression system 14, or chiller, which can be used in the HVAC&R system 10. The vapor compression system 14 may circulate a working fluid through a circuit (e.g., working fluid circuit, refrigerant circuit) starting with a compressor 32, such as a centrifugal compressor. The circuit may also include a condenser 34, an expansion valve(s) or device(s) 36, and an evaporator 38. The vapor compression system 14 may further include a control panel 40 that has an analog to digital (A/D) converter 42, a microprocessor 44, a non-volatile memory 46, and/or an interface board 48.

Some examples of fluids that may be used as working fluids (e.g., refrigerants) in the vapor compression system 14 are hydrofluorocarbon (HFC) based working fluids, for example, R-410A, R-407, R-134a, hydrofluoro olefin (HFO), “natural” working fluids like ammonia (NH₃), R-717, carbon dioxide (CO₂), R-744, or hydrocarbon-based working fluids, water vapor, or any other suitable working fluid. Other possible working fluids include R-123, R-514A, R-1224yd, R-1233zd, R-134a, R-1228ze, R-1228yf, R-1311, R-32, and R-410A. In some embodiments, the vapor compression system 14 may be configured to efficiently utilize working fluids having a normal boiling point of about 19 degrees Celsius (66 degrees Fahrenheit) at one atmosphere of pressure, also referred to as low pressure working fluids, versus a medium pressure working fluid, such as R-134a. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 during a normal operating mode and may be powered by a variable speed drive (VSD) 52. The VSD 52 receives alternating current (AC) power during the normal operating mode, where the AC power includes a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a working fluid vapor and delivers the vapor to the condenser 34 through a discharge passage. In some embodiments, the compressor 32 may be a centrifugal compressor. The working fluid vapor delivered by the compressor 32 to the condenser 34 may transfer heat to a cooling fluid (e.g., water or air) in the condenser 34. The working fluid vapor may condense to a working fluid liquid in the condenser 34 as a result of thermal heat transfer with the cooling fluid. The liquid working fluid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser 34.

The liquid working fluid delivered to the evaporator 38 may absorb heat from a conditioning fluid that is subsequently routed to a load 62 (e.g., the building 12 of FIG. 1). For example, the conditioning fluid may be cooled by the working fluid in the evaporator 38, and then may be utilized in the building 12 of FIG. 1 to condition an air flow provided to condition a space in the building 12. The liquid working fluid in the evaporator 38 may undergo a phase change from the liquid working fluid to a working fluid vapor. As shown in the illustrated embodiment of FIG. 3, the evaporator 38 may include a tube bundle 58 having a supply line 60S and a return line 60R connected to the cooling load 62. The conditioning fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the conditioning fluid in the tube bundle 58 via thermal heat transfer with the working fluid. The tube bundle 58 in the evaporator 38 can include a plurality of tubes and/or a plurality of tube bundles. In any case, the vapor working fluid exits the evaporator 38 and returns to the compressor 32 by a suction line to complete the cycle.

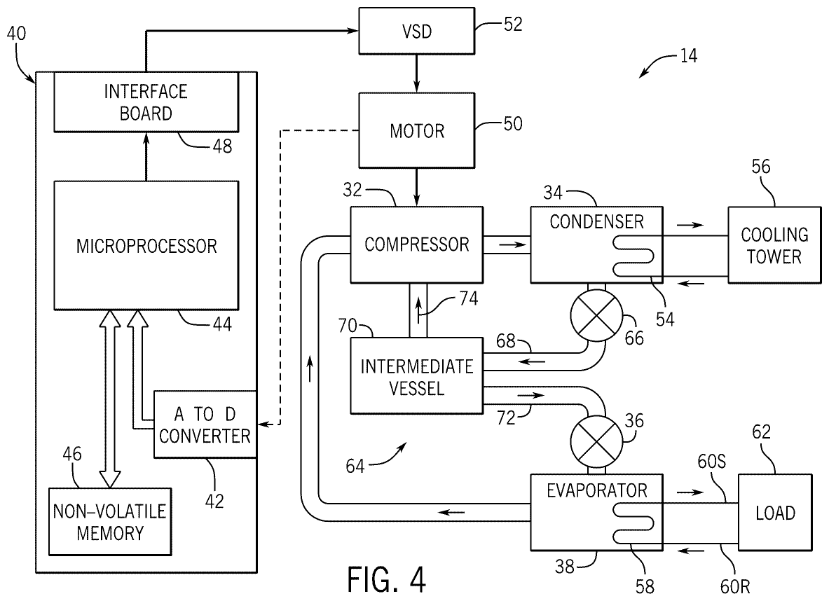

FIG. 4 is a schematic of an embodiment of the vapor compression system 14 with an intermediate circuit 64 incorporated between the condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the liquid working fluid received from the condenser 34. During the expansion process, a portion of the liquid working fluid may vaporize, and thus, the intermediate vessel 70 may be used to separate the vapor working fluid from the liquid working fluid received from the first expansion device 66. Additionally, the intermediate vessel 70 may provide for further expansion of the liquid working fluid due to a pressure drop experienced by the liquid working fluid when entering the intermediate vessel 70 (e.g., due to a rapid increase in volume experienced when entering the intermediate vessel 70). The vapor working fluid in the intermediate vessel 70 may be drawn by the compressor 32 through a suction line 74 of the compressor 32. In other embodiments, the vapor working fluid in the intermediate vessel 70 may be drawn to an intermediate stage of the compressor 32 (e.g., not the suction stage). The liquid working fluid that collects in the intermediate vessel 70 may be at a lower enthalpy than the liquid working fluid exiting the condenser 34 due to expansion of the working fluid at the expansion device 66 and/or in the intermediate vessel 70. The liquid working fluid from intermediate vessel 70 may then flow through line 72 and through a second expansion device 36 to the evaporator 38.

In accordance with present embodiments, the compressor 32 may be a centrifugal compressor (e.g., a hermetic compressor) having a levitated rotor or shaft. To this end, the vapor compression system 14 includes a bearing system with one or more primary bearings configured to support a load of the shaft of the compressor 32. The bearing system is configured to direct a pressurized fluid (e.g., liquid) through the primary bearings, and the primary bearings are configured to discharge the fluid toward and against the shaft in order to enable levitation of the shaft within the compressor 32. Specifically, the primary bearings include one or more porous bearing elements configured to receive the pressurized fluid and direct the pressurized fluid toward the shaft (e.g., radially inward) within a housing of the compressor 32. In this way, the bearing system may support a load on the shaft and enable rotation of the shaft within the housing of the compressor 32 during operation of the vapor compression system 14. As discussed herein, the pressurized fluid may be a working fluid (e.g., refrigerant) circulated through the vapor compression system 14. Thus, the vapor compression system 14 may not utilize a dedicated lubricant, such as oil, to support and enable rotation of the shaft of the compressor 32. Further, the bearing system may be incorporated with the vapor compression system 14 at reduced costs, as compared to other existing bearing system designs. In accordance with present techniques, the compressor 32 also includes one or more backup bearings, in addition to the primary bearings, as described in further detail below.

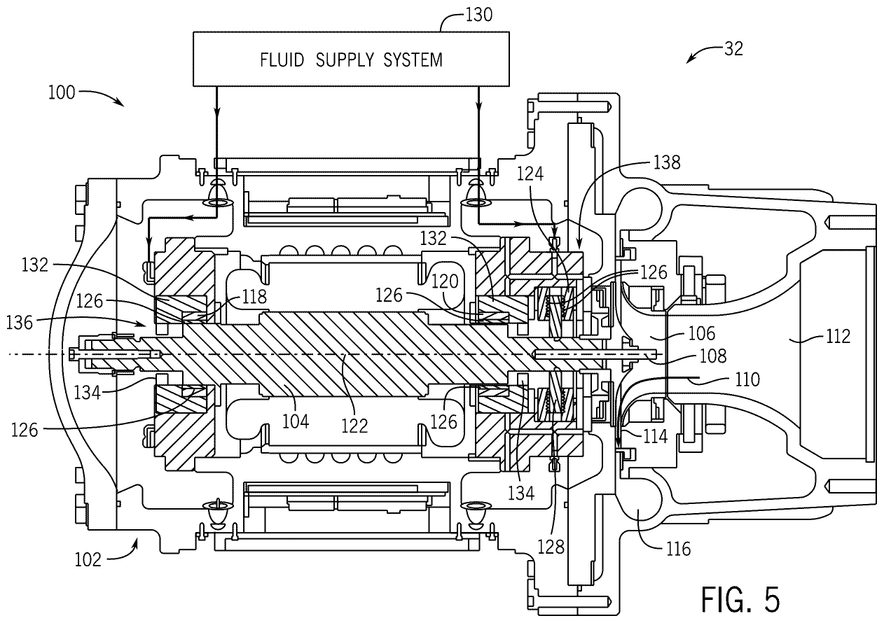

With the foregoing in mind, FIG. 5 is a cross-sectional side view of an embodiment of the compressor 32 including a bearing system 100, in accordance with aspects of the present disclosure. The compressor 32 may include a housing 102 and a shaft 104 extending through the housing 102. The compressor 32 may also include an impeller 106 coupled to the shaft 104, such as via a fastener 108. During operation of the compressor 32, the shaft 104 may rotate (e.g., via operation of the motor 50) and cause rotation of the impeller 106. Rotation of the impeller 106 may drive a working fluid (e.g., refrigerant) to flow through a working fluid flow path 110 (e.g., from the evaporator 38, from the intermediate vessel 70, working fluid circuit) to draw the working fluid into the housing 102 via a suction inlet 112 and toward the impeller 106. The impeller 106 may impart mechanical energy onto the working fluid and discharge the working fluid to a diffuser passage 114 of the compressor 32. The working fluid may be directed from the diffuser passage 114 to a volute 116 of the compressor 32 and from the volute 116 to a condenser (e.g., the condenser 34) for heat exchange with a fluid, such as a cooling fluid.

In the illustrated embodiment, the compressor 32 (e.g., bearing system 100) includes a first primary bearing 118 (e.g., a radial bearing, hydrodynamic bearing, porous bearing) and a second primary bearing 120 (e.g., a radial bearing, hydrodynamic bearing, porous bearing) configured to control and/or adjust a position (e.g., radial position) of the shaft 104 relative to an axis 122 (e.g., rotational axis, central axis) of the shaft 104. For example, the first primary bearing 118 and the second primary bearing 120 may be disposed about (e.g., annularly disposed about) the shaft 104 and configured to support a load of the shaft 104, such that the shaft 104 levitates within the first primary bearing 118 and the second primary bearing 120. The first primary bearing 118 and the second primary bearing 120 may also be configured to block movement (e.g., bending, radial movement, eccentric rotation) of the shaft 104 crosswise to the axis 122. The compressor 32 (e.g., bearing system 100) further includes a third primary bearing 124 (e.g., thrust bearing, axial bearing, bearing assembly, porous bearing) configured to control and/or adjust a position (e.g., axial position) of the shaft 104 along the axis 122. For example, the third bearing 124 may be configured to block or limit movement (e.g., translation) of the shaft 104 along the axis 122.

As mentioned above, the bearing system 100 is configured to direct a pressurized fluid to the primary bearings of the bearing system 100, such as the first primary bearing 118, the second primary bearing 120, and/or the third primary bearing 124. The pressurized fluid may be the same working fluid (e.g., refrigerant) circulated through the vapor compression system 14 (e.g., working fluid flow path 110) having the compressor 32. However, it should be appreciated that the pressurized fluid may be any suitable fluid, such as a refrigerant, a condensable vapor, or other fluid. In some embodiments, the first primary bearing 118, the second primary bearing 120, and/or the third primary bearing 124 each include one or more porous elements 126 (e.g., pad portions) configured to direct the pressurized fluid therethrough. For example, the one or more porous elements 126 of the first primary bearing 118 and the second primary bearing 120 may be configured to received pressurized fluid and direct the pressurized fluid towards the shaft 104 to establish a high-pressure fluid film (e.g., vapor film) about the shaft 104 between the first primary bearing 118 and the second primary bearing 120 and the shaft 104. For example, the first primary bearing 118 and the second primary bearing 120 may direct (e.g., discharge, spray) the pressurized fluid radially inward (e.g., toward an axial center of the bearings). In this way, the pressurized fluid may cause the shaft 104 to levitate from the first primary bearing 118 and the second primary bearing 120, thereby enabling desired rotation of the shaft 104 about the axis 122. The one or more porous elements 126 of the third primary bearing 124 may receive pressurized fluid and direct the pressurized fluid towards a collar 128 (e.g., thrust collar) of the third primary bearing 124. In this way, the pressurized fluid may apply a force to the collar 128 and enable adjustable positioning of the shaft 104 along the axis 122.

The bearing system 100 includes a fluid supply system 130 configured to supply pressurized fluid to the primary bearings (first primary bearing 118, second primary bearing 120, and/or third primary bearing 124) of the bearing system 100. For example, the fluid supply system 130 may direct the pressurized fluid to the housing 102 and through the housing 102 of the compressor 32 to one or more bearing housings 132 (e.g., casings) containing the first primary bearing 118, the second primary bearing 120, and/or the third primary bearing 124. In the illustrated embodiment, one bearing housing 132 is associated with the first primary bearing 118, and another bearing housing 132 is associated with the second primary bearing 120. An additional bearing housing 132 may be utilized with the third primary bearing 124. In other embodiments, the second primary bearing 120 and the third primary bearing 124 may be packaged together in a common bearing housing 132. The pressurized fluid may be directed through the bearing housings 132 to the corresponding porous elements 126 retained within each bearing housing 132. It should be appreciated that the compressor 32 may include any suitable number or type (e.g., radial, axial) of bearings incorporating the present techniques, and the primary bearings may be positioned at any suitable location within the housing 102 of the compressor 32.

The compressor 32 (e.g., bearing system 100) further includes one or more backup bearings 134 (e.g., second bearings) configured to support and enable rotation of the shaft 104, such as during instances in which operation of the primary bearings (e.g., first primary bearing 118 and/or second primary bearing 120) is inadvertently (e.g., unexpectedly) interrupted and/or otherwise adversely impacted. In some embodiments, each backup bearing 134 may be associated with and/or positioned adjacent to a respective primary bearing (e.g., the first primary bearing 118 or the second primary bearing 120). In the illustrated embodiment, each of the backup bearings 134 is housed with the first bearing 118 or the second bearing 120 within the bearing housing 132 corresponding to the first bearing 118 or the second bearing 120. That is, a first bearing assembly 136 of the bearing system 100 may include one of the bearing housings 132 that encases the first primary bearing 118 and one of the backup bearings 134. Likewise, a second bearing assembly 138 of the bearing system 100 may include another bearing housing 132 that contains the second primary bearing 120 and another backup bearing 134. In some embodiments, the second bearing assembly 138 may also include the third primary bearing 124 supported by the corresponding bearing housing 132. In other embodiments, the backup bearings 134 may each be housed within separate respective bearing housings 132 (e.g., backup bearing housings).

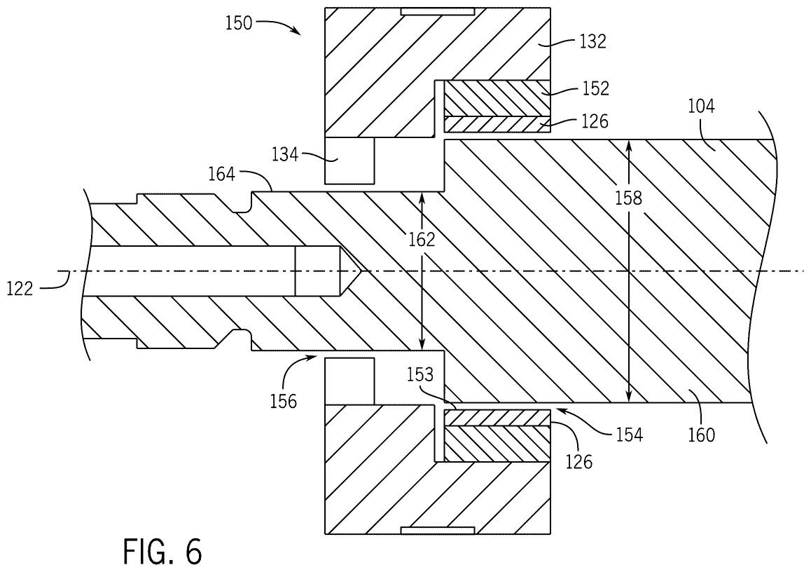

FIG. 6 is a detailed cross-sectional side view of an embodiment of a portion of the compressor 32 including a bearing assembly 150, in accordance with aspects of the present disclosure. For example, the bearing assembly 150 may be an embodiment of the first bearing assembly 136 or the second bearing assembly 138 discussed above. In other words, the bearing assembly 150 is a radial bearing assembly configured to support (e.g., levitate) the shaft 104 within the housing 102 of the compressor 32 to enable rotation of the shaft 104. The bearing assembly 150 includes the bearing housing 132 and a primary bearing 152 (e.g., a first bearing, the first primary bearing 118 or the second primary bearing 120, porous bearing) that is supported (e.g., retained) within the bearing housing 132. As such, the primary bearing 152 is disposed about (e.g., around, annularly disposed about) the shaft 104 in a fixed position relative to the housing 102 of the compressor 32. The primary bearing 152 is configured to receive pressurized working fluid (e.g., refrigerant) from the fluid supply system 130 and discharge the pressurized working fluid from the porous elements 126 of the primary bearing 152. In this way, the pressurized working fluid may impinge against the shaft 104 to cause the shaft 104 to lift from the primary bearing 152 and levitate within the bearing assembly 150.

The bearing assembly 150 further includes an embodiment of the backup bearing 134 (e.g., second bearing) disposed within the bearing housing 132. In some embodiments, in an installed configuration of the bearing assembly 150 within the compressor 32 and about the shaft 104, the backup bearing 134 may be positioned outboard of the primary bearing 152 (e.g., relative to a longitudinal or length-wise center of the shaft 104, relative to a stator of the motor 50). As discussed above, the backup bearing 134 is supported by (e.g., coupled to, mounted to) the bearing housing 132, and the backup bearing 134 is disposed about (e.g., around, annularly disposed about) the shaft 104. Thus, during interrupted operation of the primary bearing 152, the backup bearing 134 may engage with and support the shaft 104 and may enable continued rotation of the shaft 104 within the bearing assembly 150. For example, a pressure of working fluid supplied to and/or discharged from the porous elements 126 of the primary bearing 152 may drop in some circumstances, such as during operational interruption of the fluid supply system 130. As another example, supply of the pressurized fluid to the primary bearing 152 may be inadvertently interrupted, such as due to interruption in a supply of power to the HVAC&R system 10 (e.g., fluid supply system 130). In other instances, mechanical degradation of the primary bearing 152 may cause operational interruption of the primary bearing 152. As a result, the primary bearing 152 may no longer operate to lift or levitate the shaft 104 within the bearing assembly 150 via the pressurized working fluid. In such instances, the shaft 104, no longer levitated by the pressurized working fluid, may contact an inner surface 153 (e.g., inner annular surface) of the primary bearing 152. However, without pressurized fluid directed through the primary bearing 152, the inner surface 153 of the primary bearing 152 may not adequately support and/or enable rotation of the shaft 104. In such circumstances, the shaft 104 may also contact the backup bearing 134. Thus, the backup bearing 134 may at least partially support a load of the shaft 104. Additionally, the backup bearing 134 may provide a bearing interface between the backup bearing 134 and the shaft 104 to enable reduced friction therebetween. In this way, the backup bearing 134 may enable continued rotation of the shaft 104. For example, the backup bearing 134 may enable a controlled deceleration of the shaft 104, such as during shutdown of the compressor 32. In this way, the backup bearing 134 may mitigate wear and degradation to the compressor 32 and components of the compressor 32 (e.g., the motor) that may otherwise be caused during interrupted operation of the primary bearing 152.

As mentioned above, during operation of the primary bearing 152, the backup bearing 134 may not engage with (e.g., contact) the shaft 104. For example, the backup bearing 134 may be configured to establish a clearance (e.g., second clearance, backup clearance) between the shaft 104 and the backup bearing 134 (e.g., inner annular surface of the backup bearing 134). The clearance between the shaft 104 and the backup bearing 134 may be greater than a clearance (e.g., first clearance, primary clearance) established between the primary bearing 152 (e.g., porous elements and/or inner surface(s) of the primary bearing 152) and the shaft 104 during operation of the primary bearing 152. That is, the primary bearing 152 may cause the shaft 104 to levitate a first distance 154 extending (e.g., radially) from the inner surface of the primary bearing 152 during operation of the primary bearing 152. Additionally, during operation of the primary bearing 152, the backup bearing 134 may be positioned to maintain a clearance having a second distance 156 extending (e.g., radially) between the inner surface of the backup bearing 134 and the shaft 104. In other words, the backup bearing 134 may be concentric with the shaft 104, and an inner radius of the backup bearing 134 may be greater than a radius of the shaft 104 by the second distance 156 at an axial location of the backup bearing 134 along the shaft 104. In some embodiments, the second distance 156 may be greater than the first distance 154 by any suitable amount, such as approximately 3 millimeters (mm), 2 mm, 1 mm, 0.5 mm, 0.25 mm, 0.1 mm, 0.01 mm, or any other suitable distance. Additionally or alternatively, the second distance 156 may be greater than the first distance 154 by a factor of 1.1, 2, 5, 10, or any other suitable factor. While the second distance 156 is greater than the first distance 154, the second distance 156 may be selected (e.g., via configuration of the backup bearing 134, the shaft 104, or both) such that the backup bearing 134 is configured to enable adequate or proper alignment of the shaft 104 (e.g., along the axis 122, relative to the axis 122) during instances in which the primary bearing 152 does not operate and the backup bearing 134 contacts and supports the shaft 104. In this way, the backup bearing 134 may mitigate reduced wear and degradation, as well as controlled operation and/or shutdown, of the compressor 32 during interrupted operation of the primary bearing 152. Additionally, in accordance with present techniques, a tolerance (e.g., manufacturing tolerance) of the inner diameter of the backup bearing 134 may be greater than a tolerance (e.g., manufacturing tolerance) of the inner diameter of the primary bearing 152, for example, to accommodate thermal expansion of the backup bearing 134 and/or shaft 104 during operation of the compressor 32.

In the illustrated embodiment, a diameter of the shaft 104 varies along a length of the shaft 104 (e.g., along the axis 122). For example, a first diameter 158 of the shaft 104 along a first portion 160 of the shaft 104 is greater than a second diameter 162 along a second portion 164 of the shaft 104. The primary bearing 152 may be disposed (e.g., annularly) about the first portion 160, and the backup bearing 134 may be disposed (e.g., annularly) about the second portion 164. Accordingly, a magnitude of the inner diameter of the primary bearing 152 may be a sum of a magnitude of the first diameter 158 and twice a magnitude of the first distance 154. Additionally, a magnitude of the inner diameter of the backup bearing 134 may be a sum of a magnitude of second diameter 162 and twice a magnitude of the second distance 156.

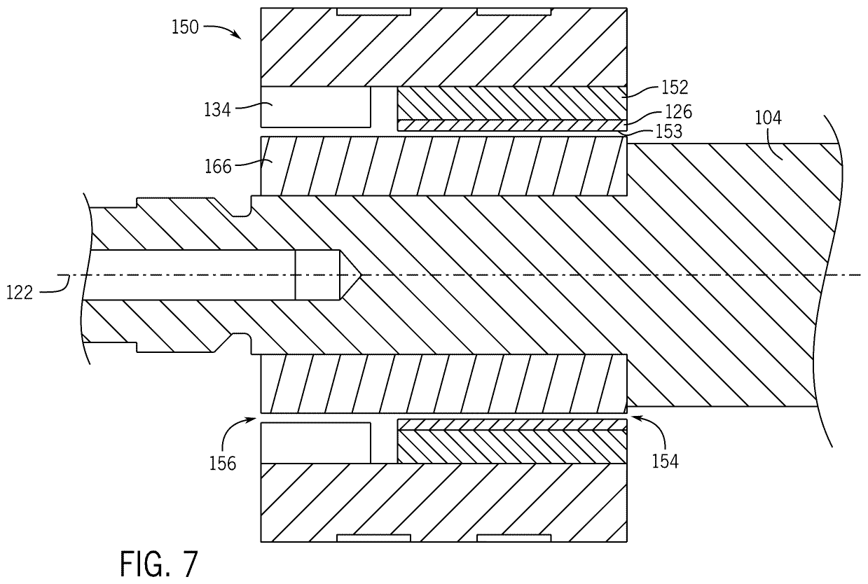

FIG. 7 is a detailed cross-sectional view of another embodiment of a portion of the compressor 32, illustrating the bearing assembly 150 and a sleeve 166 disposed about the shaft 104, in accordance with aspects of the present disclosure. The sleeve 166 may be coupled or integrally formed with the shaft 104 along at least a portion of the shaft 104, such as a portion of the shaft 104 about which the primary bearing 152 and/or the bearing assembly 150 is disposed. In some embodiments, the sleeve 166 may have a low-friction surface (e.g., outer diameter) that enables improved performance of the primary bearing 152. The sleeve 166 may additionally or alternatively include electrically conductive features, such as metallic bristles (e.g., a brush, carbon brush) positioned on an outer diameter of the sleeve 166. The electrically conductive features may contact the primary bearing 152 to establish electrical continuity between the shaft 104 having the sleeve 166 and the primary bearing 152 to indicate contact therebetween. When the shaft 104 is lifted from the primary bearing 152 during operation of the primary bearing 152, the sleeve 166 may not contact the primary bearing 152, which may interrupt the electrical continuity therebetween to indicate separation of the primary bearing 152 from the shaft 104. Based on detections of electrical continuity, electrical discontinuity, and/or electrical resistances between the shaft 104 and the primary bearing 152, operation of the compressor 32 may be adjusted or controlled. For example, a detection of electrical continuity between the primary bearing 152 and the shaft 104 may be indicative of operational interruption of the primary bearing 152 and thereby indicate contact between the shaft 104 and the backup bearing 134. Based on the detection, the HVAC&R system 10 may adjust operation of the compressor 32, for example, by initiating a shutdown sequence of the compressor 32 (e.g., motor 50).

In the illustrated embodiment, a diameter of the sleeve 166 is generally constant along a portion of the shaft 104 about which the bearing assembly 150 is disposed. As similarly discussed above, the inner diameter of the backup bearing 134 may be greater (e.g., by approximately 3 millimeters (mm), 2 mm, 1 mm, 0.5 mm, 0.25 mm, 0.1 mm, 0.01 mm, or any other suitable distance) than the inner diameter of the primary bearing 152. That is, the difference between the first distance 154 (e.g., clearance of the primary bearing 152) and the second distance 156 (e.g., clearance of the backup bearing 134) may be half the difference between the inner diameter of the backup bearing 134 and the inner diameter of the primary bearing 152.

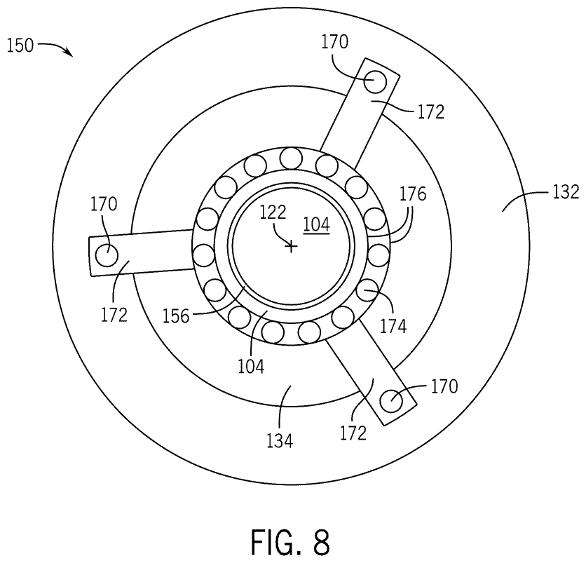

FIG. 8 is an axial view of an embodiment of the bearing assembly 150 including the primary bearing 152 and the backup bearing 134. As discussed above, the bearing assembly 150 includes the bearing housing 132, which may house both the primary bearing 152 and the backup bearing 134. For example, the backup bearing 134 may be disposed radially within the bearing housing 132 (e.g., relative to axis 122), and the backup bearing 134 may be retained within the housing 132 via fasteners 170 (e.g., mechanical fasteners, screws, bolts, etc.). The fasteners 170 may extend through one or more rigid plates 172 (e.g., retainers, extensions) and into the bearing housing 132. The rigid plates 172 may extend radially relative to the axis 122 and may overlap with (e.g., radially overlap with) the backup bearing 134 and the bearing housing 132. Thus, the rigid plates 172 may retain the backup bearing 134 within the bearing housing 132 and may block movement of the backup bearing 132 relative to the bearing housing 132 and along the axis 122.

In some embodiments, the backup bearing 134 may be a mechanical bearing. For example, the backup bearing 134 may be a ball bearing or a roller bearing having balls or rollers 174 (e.g., bearing elements) configured to roll (e.g., translate, rotate, slide) along interior walls 176 of the backup bearing 134. In this way, friction between the shaft 104 and the backup bearing 134 may be reduced. In other embodiments, the backup bearing 134 may be a sleeve bearing, a bush bearing, a journal bearing, a sliding contact bearing, a magnetic bearing, a hydrostatic bearing, a hydrodynamic bearing with an independent fluid supply system, or any other suitable type of bearing. For example, the backup bearing 134 may be a sleeve having an inner surface (e.g., diameter, skid, bearing surface) formed from a relatively soft material (e.g., bronze) configured to contact the shaft 104 and absorb an impact or force of the shaft 104.

While only certain features and embodiments have been illustrated and described, many modifications and changes may occur to those skilled in the art, such as variations in sizes, dimensions, structures, shapes and proportions of the various elements, values of parameters, such as temperatures and pressures, mounting arrangements, use of materials, colors, orientations, and so forth, without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure.

Furthermore, in an effort to provide a concise description of the exemplary embodiments, all features of an actual implementation may not have been described, such as those unrelated to the presently contemplated best mode, or those unrelated to enablement. It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A compressor for a heating, ventilation, air conditioning, and refrigeration (HVAC&R) system, comprising:
a compressor housing;
a shaft configured to rotate within the compressor housing;
a primary bearing annularly disposed about the shaft, wherein the primary bearing is configured to receive a flow of pressurized fluid and to discharge the pressurized fluid toward the shaft; and
a backup bearing annularly disposed about the shaft, wherein the backup bearing is configured to engage with the shaft during an operational interruption to the primary bearing.

2. The compressor of claim 1, wherein the primary bearing is configured to establish a first clearance distance between the primary bearing and the shaft during operation of the primary bearing, the backup bearing is disposed around the shaft at a second clearance distance between the backup bearing and the shaft, and the second clearance distance is greater than the first clearance distance.

3. The compressor of claim 1, comprising a bearing housing disposed within the compressor housing, wherein the primary bearing and the backup bearing are supported by the bearing housing.

4. The compressor of claim 1, wherein the backup bearing is a roller bearing or a ball bearing.

5. The compressor of claim 1, wherein the backup bearing is a skid bearing.

6. The compressor of claim 1, wherein the primary bearing is configured to support the shaft during non-operation of the compressor.

7. The compressor of claim 1, comprising:
a first bearing assembly, wherein the first bearing assembly comprises the primary bearing and the backup bearing; and
a second bearing assembly comprising an additional primary bearing and an additional backup bearing, wherein the additional primary bearing and the additional backup bearing are annularly disposed around the shaft,
wherein the first bearing assembly is disposed at a first end of the shaft, and the second bearing assembly is disposed about a second end of the shaft opposite the first end.

8. The compressor of claim 1, wherein the backup bearing is positioned outboard of the primary bearing relative to a longitudinal center of the shaft.

9. The compressor of claim 1, wherein the primary bearing and the backup bearing are concentric.

10. The compressor of claim 1, wherein the compressor is configured to circulate a working fluid through a working fluid circuit of the HVAC&R system, and the primary bearing is configured to receive a portion of the working fluid as the flow of pressurized fluid.

11. A heating, ventilation, air conditioning, and refrigeration (HVAC&R) system, comprising:
a compressor, comprising:
a compressor housing;
a shaft configured to rotate within the compressor housing;
a first bearing disposed about the shaft, wherein the first bearing is configured to receive a pressurized fluid and to discharge the pressurized fluid toward the shaft, and the first bearing is configured to establish a first clearance distance between the first bearing and the shaft during operation of the compressor; and
a second bearing disposed about the shaft, wherein the second bearing is configured to establish a second clearance distance between the second bearing and the shaft during operation of the shaft, wherein the first clearance distance is less than the second clearance distance; and
a fluid supply system configured to direct the pressurized fluid to the first bearing.

12. The HVAC&R system of claim 11, wherein the second bearing is configured to contact and support the shaft in response to an interruption to operation of the first bearing.

13. The HVAC&R system of claim 11, wherein the first bearing and the second bearing are disposed at an end of the shaft, and the first bearing is disposed along a longitudinal axis of the shaft between the second bearing and a longitudinal center of the shaft.

14. The HVAC&R system of claim 11, wherein the first bearing comprises a first inner diameter, and the second bearing comprises a second inner diameter greater than the first inner diameter.

15. The HVAC&R system of claim 11, wherein the second bearing is a roller bearing, a ball bearing, or skid bearing.

16. The HVAC&R system of claim 11, wherein the fluid supply system is configured to direct a refrigerant of the HVAC&R system to the first bearing as the pressurized fluid.

17. A bearing assembly for supporting a shaft of a compressor, comprising:
a primary bearing disposed about an axis of rotation of the shaft, wherein the primary bearing is configured to discharge a refrigerant inward of the primary bearing, and the primary bearing is configured to establish a first clearance distance between the shaft and the primary bearing during operation of the compressor;
a backup bearing disposed about the axis of rotation of the shaft, wherein the backup bearing is configured to encircle the shaft at a second clearance distance between the backup bearing and the shaft during operation of the compressor, wherein the second clearance distance is greater than the first clearance distance; and
a bearing housing configured to support the primary bearing and the backup bearing.

18. The bearing assembly of claim 17, wherein the backup bearing is configured to contact the shaft in response to operational interruption of the primary bearing during operation of the compressor.

19. The bearing assembly of claim 17, wherein the primary bearing is configured to support the shaft during non-operation of the compressor, such that the backup bearing does not contact the shaft during non-operation of the compressor.

20. The bearing assembly of claim 17, wherein the backup bearing comprises a roller bearing or a bronze skid bearing.
